(19) United States
(12) Patent Application Publication
(10) Pub. No.: US 2006/0122450 A1
(43) Pub. Date: Jun. 8, 2006

(54) Apparatus and method for vitrification of spent resin containing transition metals

(75) Inventors: Cheon-Woo Kim, Daejeon (KR); Jong-Kil Park, Anyang-si (KR); Sang-Woon Shin, Daejeon (KR); Jong-Hyun Ha, Daejeon (KR); Myung-Jae Song, Daejeon (KR)

Correspondence Address: Peter T. Kwon;GWiPS, Kangnam, P.O. Box 2301, Seoul, 135-242, KR

(73) Assignee: Korea Hydro & Nuclear Power Co., Ltd

(21) Appl. No.: 11/284,229

(22) Filed: Nov. 22, 2005

(30) Foreign Application Priority Data
Nov. 24, 2004 (KR) 10-2004-0096925

(51) Int. Cl. G21F 9/16; B01J 19/08; G21F 9/00

(52) U.S. Cl. 588/6; 422/186.07

(57) ABSTRACT

An apparatus for vitrification of a spent resin containing transition metals, and a method thereof are disclosed. The apparatus includes a crucible melter comprising upper and lower chamber, a wastes-frit input port positioned at a center of the upper chamber, a plurality of oxygen injectors slantly protruding from the upper and lower surfaces of the upper chamber, and being uniformly spaced a predetermined distance from each other, an ozone sparger penetrating the lower chamber toward an upper center in the lower chamber, an ozone generator positioned at a lower end of the ozone sparger to supply ozone to the ozone sparger, and an oxygen tank connected to the ozone generator. With this construction, it is possible to prevent generation or deposition of metallic alloys and sulfides not in a glass state during vitrification of the spent resin produced from a water purification system of a nuclear power plant.

### BACKGROUND OF THE INVENTION

1. Field of the Invention

The present invention relates to an apparatus and a method for vitrification of a spent resin containing transition metals. More particularly, the present invention relates to an apparatus and a method for vitrification of a spent resin containing transition metals, which can prevent the generation or deposition of metallic alloys, sulfides and the like not in a glass state during vitrification of an ion exchange resin obtained after processing radioactive contaminants comprising transition metals in a water purification system of a nuclear power plant, that is, a spent resin, into a glass material using an induction heating type cold crucible melter.

2. Description of the Related Art

As well known in the art, a spent resin generated from a chemical and volume control system (CVCs) of a nuclear power plant contains lots of transition metals such as Cr, Mn, Fe, Co, Ni, etc. which have a higher reducibility than other elements. If these transition metals are not converted into metal oxides during a process of vitrifying the spent resin, metallic alloys, sulfides and the like are deposited on the bottom of a Cold Crucible Melter (CCM) as materials not in a glass state, and form a layer having a higher electric conductivity than a molten glass on the bottom of the CCM, which can cause problems such as electrical short, thereby making it difficult to maintain a continuous and stable supply of electric energy. In addition, such a non-vitreous material can block a drain port of the glass material in the CCM, and make it difficult to drain the molten glass, resulting in stopping operation of the crucible melter.

Currently, world-widely used crucible melters for vitrification of radioactive wastes include a ceramic melter using an Inconel-690 and Mo electrode, and a plasma torch melter using a plasma heat source. The ceramic melter is generally used to treat liquid wastes composed of oxides and slurries in the form of suspension containing a trace of organic materials, and is believed not suitable for processing reductive organic materials such as spent resins, and radioactive wastes mainly composed of transition metals. As a result, investigations for vitrification of the radioactive wastes into the glass material have been avoided. The reason is that the Inconel-690 and Mo electrode used for generating electric energy within the ceramic melter suffers from electrical short due to metallic alloys and sulfides created in a reduction state during vitrification of the spent resin, thereby providing detrimental influence on a Silicon Controlled Rectifier (SCR), which is a main rectification device of an electric generator.

On the other hand, when the spent resin is processed using the plasma torch melter including the plasma heat source, most radioactive materials contained in the spent resin are volatized, and cause severe radioactive pollution during a process for discharging gas from the radioactive material. In addition, since the plasma torch melter requires frequent replacement of a plasma torch electrode, frequency of radiation exposure is also increased. Accordingly, it is found that the plasma torch melter is inappropriate for application to combustible radioactive wastes such as a spent resin containing transition metals.

### SUMMARY OF THE INVENTION

The present invention has been made to solve the above problems, and it is an object of the present invention to provide an apparatus and a method for vitrification of a spent resin containing transition metals, which can prevent deposition of Cr, Mn, Fe, Co or Ni alloys and sulfides upon vitrification of the spent resin containing the transition metals into a glass material by virtue of physical and mechanical reaction during combustion and pyrolysis of combustible dry active wastes (hereinafter, “DWAs”) by inputting the DWAs obtained in a nuclear power plant together with the spent resin into a melter in a weight ratio of 4:1 or more with respect to the spent resin.

It is a further object of the present invention to provide an apparatus and a method for vitrification of a spent resin containing transition metals, which can prevent deposition of metallic alloys and sulfides not in a glass state by inputting frit containing arsenic (As), cerium (Ce) and vanadium (V), as 5-valent elements, together with combustible DWAs and a spent resin containing transition metals at the same time into a melter, and maintaining an oxidized state of a molten glass by oxygen generated during reduction of the elements from 5-valent elements into 2 or 3-valent elements.

It is another object of the present invention to provide an apparatus and a method for vitrification of a spent resin containing transition metals, which can prevent deposition of metallic alloys and sulfides while promoting oxidation upon vitrification of a spent resin containing transition metals by injecting ozone (O₃) to a contact area between the spent resin containing the transition metals and the surface of a molten glass by use of a sparger formed of platinum (Pt) acting as an excellent catalyst for removing reductive carbon.

It is yet another object of the present invention to provide an apparatus and a method for vitrification of a spent resin containing transition metals, which can maintain a suitable injection amount of oxygen, and optimize positions and the numbers of bubblers and oxygen injectors by controlling an injection amount of ozone, an oxygen bubbling flow, and an injection amount of oxygen injected to a molten glass through the oxygen injectors during input of radioactive wastes from an upper space of the CCM in order to achieve complete combustion and pyrolysis of the input radioactive wastes.

It is yet another object of the present invention to provide an apparatus and a method for vitrification of a spent resin containing transition metals, which can be operated in such a way of continuously inputting radioactive wastes, burning non-combusted materials, mixing a molten glass, and draining the molten glass in a single cycle.

In accordance with one aspect of the present invention, the above and other objects can be accomplished by the provision of an apparatus for vitrification of a spent resin containing transition metals, including a crucible melter comprising upper and lower chamber respectively having cooling passageways formed therein to circulate cooling water, the lower chamber having an induction coil wound around an outer periphery thereof, the apparatus further including: a wastes-frit feeding port having a oxygen supply tube at one side thereof, and being positioned at a center of the upper chamber so as to protrude from upper and lower surfaces of the upper chamber; a plurality of oxygen injectors equipped to the upper chamber so as to slantly protrude from the upper and lower surfaces of the upper chamber, and being uniformly spaced a predetermined distance from each other; an ozone sparger penetrating the lower chamber toward an upper center in the lower chamber to inject ozone; an ozone generator positioned at a lower end of the ozone sparger to supply ozone to the ozone sparger; and an oxygen tank connected to the ozone generator.

### BRIEF DESCRIPTION OF THE DRAWINGS

FIG. 1 is a side sectional view illustrating an induction heating cold crucible melter in accordance with one embodiment of the present invention used for vitrification of the spent resin containing transition metals into the glass material.

FIG. 2 is a horizontally cross-sectional view of FIG. 1.

FIG. 3 is a partially cross-sectional view illustrating an ozone sparger applied to the apparatus of the present invention.

FIG. 4 is a partially cross-sectional view illustrating an ozone generator used for generating ozone, which is input to an upper center of a molten glass where combustion and pyrolysis of the spent resin containing transition metals occur.

FIG. 5 is a bottom view illustrating positions, the number, and bubbling directions of bubblers equipped on an outer surface of the bottom of the cold crucible melter.

### DESCRIPTION OF THE PREFERRED EMBODIMENTS

Preferred embodiments of the present invention will be described in detail with reference to the accompanying drawings.

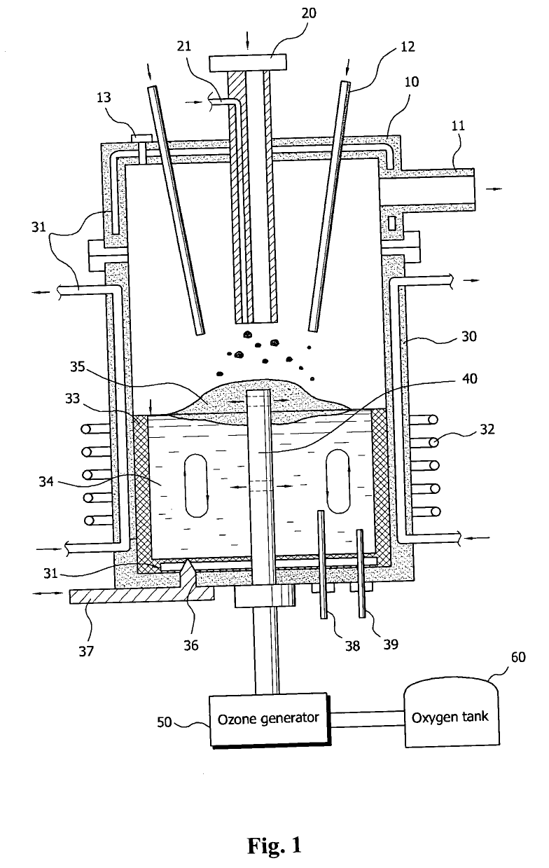

FIGS. 1 to 5 show an apparatus and a method for vitrification of the spent resin containing transition metals according to one embodiment of the present invention.

If it is determined that detailed description of related construction well known in the art is not required for clear description of the invention, the detailed description of the related construction will be omitted hereinafter.

The terms used herein are determined in consideration of functions of the apparatus of the invention, and can be changed in view of manufacturers or customs. Thus, definition of the terms must be determined on the basis of the overall contents in the specification.

First, the present invention addresses enhancement in vitrification process for preventing generation of metallic alloys and sulfides when performing the process employing a CCM (as disclosed in Korean Patent Application Nos. 10-2000-0079274 and 10-2000-0079454) used for vitrification of radioactive wastes produced from a nuclear power plant, together with optimization in operation of the CCM and development of frit for spent resin treatment.

The first technical subject for enhancement in vitrification process to be achieved by the present invention is to increase combustion efficiency of the spent resin, and allow complete oxidization of reductive elements contained in the spent resin in a molten glass with inorganic components produced during combustion of combustible dry active wastes (DAWs) by inputting the DAWs along with the spent resin.

The second technical subject is to prevent generation and deposition of metallic alloys and sulfides not in a glass state by inputting newly developed frit containing multivalent elements such as As, Ce, V, etc. along with the spent resin and the DWAs at a predetermined ratio with respect to the spent resin, followed by maintaining an oxidized state of the molten glass by virtue of a great amount of oxygen generated during reduction of the multivalent elements.

The third technical subject is to maintain strong oxidizing power in the CCM by injecting ozone (O₃), which is a strong oxidation agent through an ozone sparger positioned at the center of the CCM to which the DWA and the spent resin containing the transition metals are fed. For this purpose, the ozone sparger is made of platinum so as to act as catalysis in oxidation reaction.

In addition, the fourth technical subject is to provide stable vitrification of the spent resin by enhancing mixing and oxidizing force of the molten glass with a method of optimizing positions and the numbers of bubblers installed at the bottom of the CCM while suitably controlling a bubbling flow in view of enhancement in operation of the CCM.

The technical construction of the present invention will be described in detail hereinafter.

An apparatus of the present invention includes a crucible melter used for vitrification of the spent resin containing transition metals therein. The crucible melter comprises upper and lower chamber 10 and 30, each having a cooling passageway formed therein to circulate cooling water, and the lower crucible 30 has an induction coil 32 wound around an outer periphery thereof.

More specifically, the apparatus further includes a wastes-frit feeding port 20 having a oxygen supply tube 21 at one side thereof, and being positioned at a center of the upper chamber 10 so as to protrude from the upper and lower surfaces of the upper chamber 10; a plurality of oxygen injectors 12 equipped to the upper chamber 10 so as to slantly protrude from the upper and lower surfaces of the upper chamber 10, and being uniformly spaced a predetermined distance from each other; an ozone sparger 40 penetrating the bottom of the CCM toward an upper center in the lower chamber; an ozone generator 50 positioned at a lower end of the ozone sparger 40 to supply ozone to the ozone sparger 40; and an oxygen tank 60 connected to the ozone generator 50.

The upper chamber 10 includes a height measuring instrument 13 at an upper end thereof to measure the height of a molten glass 34 in order to prevent an ozone supply tube 43 described below from being immersed in the molten glass 34.

The lower crucible 30 includes at least one thermometer 38 at a lower end thereof to measure the temperature of the molten glass 34.

The lower chamber 30 may further include a plurality of bubblers 39 uniformly spaced a predetermined distance from each other at the lower end thereof to inject oxygen gas. Each bubbler 39 has a height of 1˜3 cm from the bottom of the CCM.

An opening/closing slide 37 having a hump is provided to a drain 36 at the lower end of the lower chamber 30, and serves to mechanically remove a solidified glass 33 on the bottom of the CCM, so that, when the molten glass 34 is discharged through the drain 36, it can be discharged in an instant.

Meanwhile, the ozone sparger 40 comprises an outer case 41, a cooling passageway 42 to supply cooling water towards an inner center of the outer case 41, an ozone supply tube 43 to supply ozone towards an upper portion of the lower chamber 30, and at least one oxygen gas supply tube 44 to supply oxygen gas towards a lower portion of the lower crucible 30.

The ozone generator 50 comprises a ceramic tube 55, which has a high voltage electrode 56 therein, a ground electrode 51 spaced a predetermined distance from the ceramic tube 55 at opposite sides of the ceramic tube 55 and contacting cooling water induced thereto, a fuse 54 connected at one end thereof with the high voltage electrode 56, and a power source 53 connected at one end thereof with the other end of the fuse 54, and at the other end with the ground electrode 51.

Reference numerals 11, 33 and 35 indicate an off-gas vent, a glass solidified by the cooling passageway 31, and the wastes, respectively.

It should be noted that the above components of the apparatus could be modified into various shapes.

With the apparatus described above, a method for vitrifying a spent resin containing transition metals according to the invention will be described hereinafter.

FIG. 1 shows a side section of a cold crucible melter (CCM) of the present invention used for treatment of radioactive wastes such as the spent resins. During a start-up operation of the CCM to make frit into a molten glass having a temperature of 1,150±30° C. in the CCM, frit of about 50˜80 kg is at first input to the CCM through a wastes-frit feeding port 20, and forms a frit layer having a height of about 16˜26 cm within the CCM. At this time, a titanium ring having a weight of about 40˜80 g is placed in the frit layer having the height of about 16˜26 cm. After filling the CCM with the frit, electric energy is applied to the CCM, and melts glass to form a molten glass, followed by injecting oxygen through bubblers 39 such that circular bubbling rings are formed along an inner wall of the lower chamber 30. At this time, it is necessary to maintain the height of the molten glass to about 14 cm or more at temperatures of 1,150±30° C. of the molten glass, and to prevent an ozone supply tube 43 positioned above an ozone sparger 40 from being immersed in the molten glass due to input of the wastes and the frit. Here, whether or not the ozone supply tube 43 is immersed in the molten glass can be monitored by a height measuring instrument 13 such as an ultrasonic transducer or a rod ruler positioned at an upper end of an upper chamber 10.

After the start-up operation of the CCM, combustible DAWs are fed to the CCM along with the spent resin at a predetermined ratio. Currently, about 70% of low and intermediate level radioactive wastes generated from the nuclear power plant comprise spent resins, protective garments, wiping towels, etc. Since the spent resin has a strong reducibility, there is a problem in that various elements including Cr, Mn, Fe, Co, Ni, etc. are reduced during combustion and pyrolysis of the spent resin, and deposited as metallic alloys and sulfides on the bottom of the CCM. In order to solve this problem, the DAWs of about 4 times or more an input amount of the spent resin containing 50˜60% moistures are input to the CCM, and serve as an oxidizing agent with respect to the spent resin, thereby preventing deposition of the metallic alloys and the sulfides.

In addition, when inputting the spent resin and the DAWs, frit containing 5-valent elements such as As, Ce, V, etc. is also fed at a predetermined ratio at the same time. As a result, the molten glass can be maintained in an oxidized state due to a great amount of oxygen produced by reduction of these elements from 5-valent into 2 and 3-valents, thereby preventing the generation or deposition of the metallic alloys and the sulfides not in a glass state. When the frit containing multivalent elements is fed to the molten glass, the multivalent elements are subjected to the reduction and oxidation reaction shown by the following expression:
4M₍ₘₑₗₜ₎^{m+}+2nO²⁻=4₍ₘₑₗₜ₎^{(m-n)+}+nO_{2(gas)}

Oxidation refers to the loss of an electron, and reduction refers to the uptake of an electron. In this expression, n indicates the number of electrons transferred from one element to another element. If the reaction proceeds from the left side to the right side, it means reduction of a cation, whereas if the reaction proceeds in the opposite direction, it means oxidation of the cation having a low valent. When the frit containing the multivalent elements is fed to the molten glass, these elements become to have a low valent, and oxygen is generated at the same time as shown in the above expression. Here, oxygen serves to prevent reduction of elements having a high reducibility into the metallic alloys or the sulfides. At this time, As, Ce, and V contained in the frit are not deposited as the metallic alloys or the sulfides. In addition, it is important to supply oxygen gas (O₂) through a plurality of oxygen injectors 12 equipped to the upper chamber 10 towards an upper portion of the CCM in order to maintain oxidation atmosphere of the molten glass while ensuring complete combustion of the wastes while simultaneously feeding the wastes and the DAWs. It is necessary to substantially remove unburned residues and unburned carbon from dust in the emission gas by supplying oxygen of 1.4˜1.8 times a stoichiometric amount of oxygen required for complete burning. If oxygen is supplied more than 1.8 times the stoichiometric amount of oxygen, it becomes uneconomical since oxygen gas not used for combustion and pyrolysis of the wastes is discharged as the emission gas.

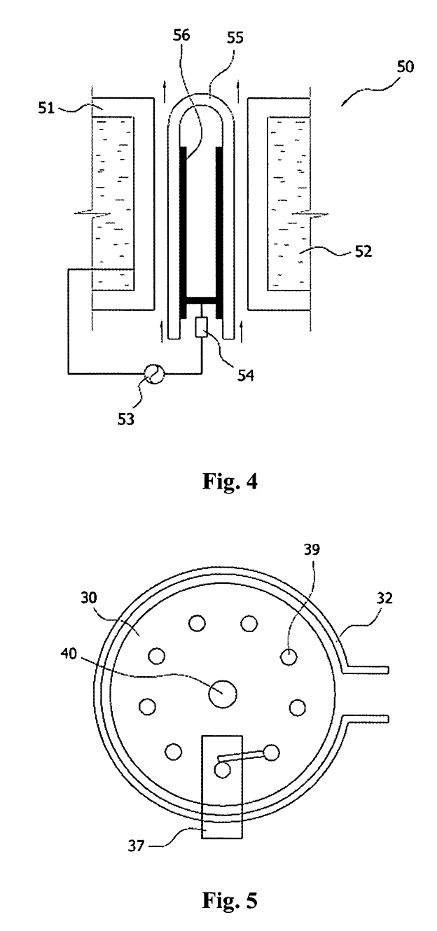

In addition, ozone (O₃) known as a strong oxidizing agent is injected through an ozone sparger 40 to a central region of the lower chamber 30 where the wastes are accumulated, thereby allowing non-oxidized inorganic materials to be completely oxidized during the combustion and the pyrolysis. Since ozone is subjected to a rapid reaction wherein one of three oxygen atoms is rapidly given to other materials, and thus acts as a powerful oxidizing agent, it oxidizes many organic or inorganic compounds. Since it is necessary to supply ozone at a rate of 5 Nm³ or more per hour through the ozone sparger 40 of the lower chamber 30, a suitable ozone generator is needed to satisfy this requirement. As for such an ozone generator, a high voltage silent discharge type ozone generator shown in FIG. 4 is commonly used. Referring to FIG. 4, the high voltage silent discharge type ozone generator comprises a high voltage electrode 56 provided inside a glass or ceramic tube, and a ground electrode 51 separated from the tube while contacting cooling water. With application of a high alternative voltage (6,000 V or more) to this ozone generator, corona discharge occurs in a gap between an insulation material and the ground electrode 51, and when oxygen passes through the gap, ozone is generated. Since ozone generation is an exothermic reaction, supply of oxygen at a high temperature causes a reverse reaction. Thus, it is necessary to maintain a predetermined temperature during this reaction, and this relationship can be described by the following expression:
3O₂+Electric energy=2O₂+68 Kcal

Specifically, about 285 kJ (i.e., 0.9 Wh/1 g of O₃) is theoretically required to generate 2 moles (96 g) of O₃. However, in practice, it is known that electric energy of 20 times (i.e., 15˜20 Wh/1 g of O₃) the theoretical energy is required. Meanwhile, although an oxygen supplier, an electric supplier, an ozone contact system, an excess ozone treatment device, an ozone amount measurement instrument, and a controller are required in addition to the ozone generator, detailed description thereof will be omitted hereinafter.

Ozone is injected through ozone supply tubes 43 shown in FIG. 3 to a region where the combustion and pyrolysis of the wastes occur. Meanwhile, during input of the spent resin and the DAWs, oxygen is supplied to the CCM at a rate of 0.3 Nm³/h or less so as not to greatly influence mixing of the molten glass through six or more oxygen gas supply tubes 44, each of which has a diameter of 0.1˜0.2 cm, and is located at a position separated a distance of 4˜6 cm from the bottom of the lower chamber 30. With supply of oxygen at the rate of 0.3 Nm³/h or less therethrough during input of the spent resin and the DAWs, each of the oxygen gas supply tube 44 is prevented from being blocked. Then, after stopping input of the wastes, the molten glass is mixed using the oxygen gas supply tubes 44. If a bubbling flow is higher than the oxygen gas supply tubes 44, there occurs a phenomenon that the molten glass swells up during the operation of the CCM. While injecting ozone through the ozone sparger 40, the height of the molten glass must be monitored so as to be located lower than openings of the ozone supply tubes 43 and so as to prevent the ozone supply tubes 43 from being immersed in the molten glass. In this regard, an important point is a material constituting the ozone sparger 40. In other words, although a conventional ozone sparger is made of water cooled stainless steel, it is desirable that the ozone sparger 40 is made of a material, which can serve as a catalyst to accelerate combustion and pyrolysis of the wastes by the oxidation reaction in the CCM. Platinum (Pt) is known as an excellent catalyst, which promotes oxidization of reductive materials. Since the platinum catalyst serves to assist efficient progress of the combustion and pyrolysis system of the reductive wastes into the oxidation and reduction reaction within the system without being changed in amount and property thereof, it has been widely applied to the field of analytical chemistry.

In order to prevent the deposition of the metallic alloys and the sulfides while maintaining the oxidized state of the molten glass during the input of the spent resin and the DAWs to the CCM, 9 or more bubblers 39 may be installed on the bottom of the CCM so as to be separated a distance of 10˜15 cm from the inner wall of the lower chamber 30 as shown in FIG. 5. When oxygen is supplied at a rate of 0.5 Nm³/h or more to the molten glass having a viscosity of 10˜100 poises through each bubbler 39, continuous oxygen bubbling rings are formed along the inner wall of the lower crucible 30. One of the functions of these oxygen bubbling rings is to oxidize remaining inorganic materials after combustion of the wastes at an upper central portion of the molten glass, and then homogeneously mix the molten glass with the inorganic materials, thereby guiding the inorganic materials to be chemically coupled with the glass structure.

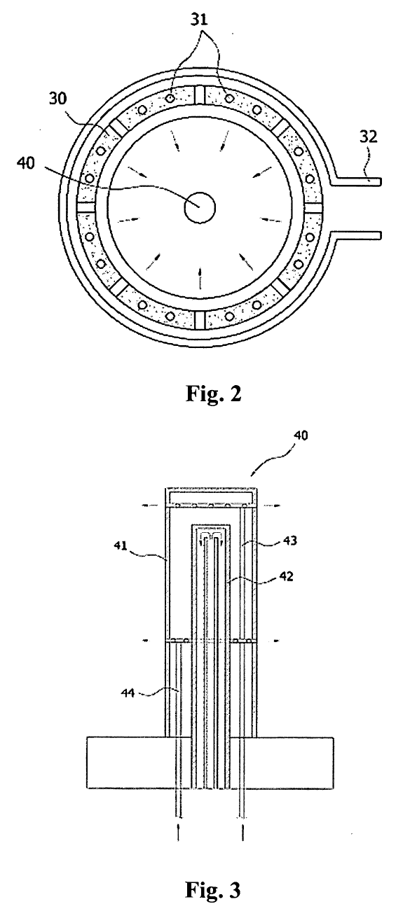

Another function of these oxygen bubbling rings is to prevent non-burned wastes accumulated at the upper central portion of the molten glass from moving and sticking to the wall of the CCM, and from being immersed in the molten glass. Most preferably, each bubbler 39 has a height of 1˜3 cm from the bottom of the lower crucible 30. If the bubbler 39 has a height less than 1 cm, bubbling cannot be efficiently achieved due to a solidified glass material on the bottom of the CCM, whereas if the bubbler 39 has a height more than 3 cm, the molten glass cannot be mixed on the bottom of the lower chamber 30, causing a decrease in temperature at a lower portion of the molten glass, and gradually solidifying the molten glass. In order to prevent physical and chemical corrosion, it is necessary that the bubblers 39 are made of stainless steel, and include cooling passageways formed therein to cool the bubblers 39. In addition, oxygen is erupted through the bubblers 39 to the central region of the CCM as shown in FIG. 2 instead of being erupted directly from an upper surface of the molten glass, thereby allowing the combustion and the pyrolysis of the wastes to be performed at the central region of the CCM. If the wastes move to the wall of the CCM, the pyrolysis of the wastes is delayed on the wall of the CCM due to its lower temperature resulting from water cooling.

One example of vitrifying the spent resin into the glass material according to the apparatus and method of the present invention will be described as follows.

Example: Operation of an apparatus for vitrification of radioactive wastes including spent resins, and a method thereof. In order to vitrify spent resins composed of anionic/cationic combined spent resins, the spent resins were fed at a rate of 4˜20 kg per hour, and various DAWs (for example, working dresses, socks, cotton gloves, indoor shoes, wiping towels, paper dresses, rubber gloves, rubber shoes, mixtures in a reagent bottle) were fed at a rate of 16˜80 kg per hour into a molten glass having a temperature of 1,150±30° C. in the CCM under the condition that the molten glass is maintained in its components and oxidized state through input of frit containing As, Ce and V at a rate of 2.2˜11 kg per hour. In order to achieve complete combustion of the input spent resins and the DAWs, ozone was injected into the CCM through at least one ozone sparger while oxygen was input through nine or more bubblers 39, and six or more oxygen injectors such that 40˜80% of excess oxygen could be supplied into the CCM. The CCM was operated in such a way of continuously inputting the wastes for 4 hours, followed by burning un-burned wastes for 10 minutes, and sufficiently mixing the molten glass for 10 minutes to make the molten glass to be homogenous. Finally, an increased amount of liquid glass due to input of the frit and the wastes is drained out of the CCM for 10 minutes. Accordingly, the process of vitrifying the spent resins requiring a total of 4.5 hours in one cycle as described above was repetitiously performed. The method for vitrification of the spent resins and the DAWs is summarized in Table 1, and components and properties of the frit input along with the wastes are summarized in Table 2.

TABLE 1
Method for vitrification of spent resins and DAWs

| | | Condition for vitrification |
|---|---|---|
| Wastes for | Spent resin | anionic/cationic combined spent resins |
| vitrification | DAWs | Various DAWs (working dresses, socks, |
| | | cotton gloves, indoor shoes, wiping |
| | | towels, paper dresses, rubber gloves, |
| | | rubber shoes, mixtures in a reagent |
| | | bottle) |

| | |
|---|---|
| Feed rate of wastes (kg/h) | 20˜100 (spent resins:DAWs = |
| | 4˜20:16˜80) |
| Feed rate of frit (kg/h) | 2.2˜11.0 |
| Excess oxygen (%) | 40˜80% |
| Injection rate of ozone | >5.0 × (one or more) |
| (Nm³/h) × the number | |
| of spargers | |
| Oxygen bubbling flux | >5.0 × (nine or more) |
| (Nm³/h) × the number | |
| of bubblers | |
| Injection rate of oxygen | >4.0 × (six or more) |
| (Nm³/h) × the number | |
| of oxygen injectors | |
| Operation period of time | Continuous input of wastes for 4 |
| | hours + Burning of unburned wastes |
| | for 10 minutes + mixing of molten |
| | glass for 10 minutes + Draining of |
| | increased molten glass for 10 |
| | minutes in one cycle (4.5 hours) |
| Temperature of molten glass | 1,150 ± 30° C. |

TABLE 2
Components and properties of frit

| Components and properties | Frit (wt %) |
|---|---|
| Al₂O₃ | 14.00 |
| As₂O₃ | 2.50 |
| B₂O₃ | 8.00 |
| Ce₂O₅ | 1.04 |
| Li₂O | 2.80 |
| Na₂O | 24.30 |
| NiO | 1.55 |
| P₂O₅ | 0.13 |
| SiO₂ | 42.00 |
| V₂O₅ | 3.81 |
| ZrO₂ | 1.55 |
| Viscosity (Poise at 1,150° C.) | 34 |
| Electric conductivity (S/cm at 1,150 ° C.) | 0.80 |

As apparent from the above description, the apparatus and method according to the present invention can stably vitrify the spent resins containing transition metals, which are produced as radioactive wastes from the nuclear power plant. One of the advantageous effects of the present invention is that, since it is possible to fundamentally prevent metallic alloys and sulfides having a high reducibility from being produced or deposited on the bottom of the CCM during vitrification of the spent resins containing the transition metals, the process of vitrification can be continuously and stably performed while producing homogeneous solidified glass materials. In addition, the present invention can be applied to other melters including a ceramic melter as well as the CCM.

Furthermore, since it is possible to obtain a volume reduction ratio of about 92 through vitrification of the spent resin along with the DAWs as targets for vitrification, in which the volume reduction ratio of the spent resin is evaluated to about 42, it is evaluated that the invention achieves a remarkable effect in terms of the volume reduction ratio. As a result, disposal costs for such radioactive wastes can be remarkably reduced while maximizing safety during the disposal through vitrification according to the invention.

It should be understood that the embodiments and the accompanying drawings have been described for illustrative purposes and the present invention is limited by the following claims. Further, those skilled in the art will appreciate that various modifications, additions and substitutions are allowed without departing from the scope and spirit of the invention as set forth in the accompanying claims.

What is claimed is:

1. An apparatus for vitrification of a spent resin containing transition metals, including a crucible melter comprising upper and lower chamber respectively having cooling passageways formed therein to circulate cooling water, the lower chamber having an induction coil wound around an outer periphery thereof, the apparatus further including:
a wastes-frit feeding port having an oxygen supply tube at one side thereof, and being positioned at a center of the upper crucible so as to protrude from upper and lower surfaces of the upper chamber;
a plurality of oxygen injectors equipped to the upper chamber so as to slantly protrude from the upper and lower surfaces of the upper chamber, and being uniformly spaced a predetermined distance from each other;
an ozone sparger penetrating the lower chamber toward an upper center in the lower chamber to inject ozone;
an ozone generator positioned at a lower end of the ozone sparger to supply ozone to the ozone sparger; and
an oxygen tank connected to the ozone generator.

2. The apparatus as set forth in claim 1, further including: a height measuring instrument positioned at an upper end of the upper chamber to measure a height of a molten glass in order to prevent an ozone supply tube from being immersed in the molten glass.

3. The apparatus as set forth in claim 1, further including: at least one thermometer positioned at a lower end of the lower chamber to measure a temperature of the molten glass.

4. The apparatus as set forth in claim 1, further including: a plurality of bubblers uniformly spaced a predetermined distance from each other at a lower end of the lower chamber to form continuous bubbling rings in the crucible melter such that the wastes are prevented from moving to a wall of the crucible melter, and from being immersed in the molten glass.

5. The apparatus as set forth in claim 4, wherein each bubbler has a height of 1˜3 cm from the bottom of the lower chamber to allow bubbling of the molten glass on the bottom of the crucible melter to be efficiently performed while preventing solidification of the molten glass.

6. The apparatus as set forth in claim 1, further including: an opening/closing slide 37 having a hump provided to a drain of the crucible melter at the lower end of the lower chamber, the hump of the opening/closing slide mechanically removing a solidified glass, thereby allowing the molten glass to be discharged in an instant when discharging the molten glass.

7. The apparatus as set forth in claim 1, wherein the ozone sparger comprises an outer case, a cooling passageway to supply cooling water towards an inner center of the outer case, an ozone supply tube to supply ozone towards an upper portion of the lower chamber, and at least one oxygen gas supply tube to supply oxygen gas towards a lower portion of the lower chamber.

8. The apparatus as set forth in claim 1, wherein the ozone generator comprises a ceramic tube having a high voltage electrode therein, a ground electrode spaced a predetermined distance from the ceramic tube at opposite sides of the ceramic tube and contacting cooling water induced thereto, a fuse connected at one end with the high voltage electrode, and a power source connected at one end with the other end of the fuse and at the other end with the ground electrode.

9. A method for vitrifying a spent resin containing transition metals, wherein combustible dry active wastes (DAWs) are input along with the spent resin containing the transition metals to a crucible melter in order to prevent metallic alloys and sulfides from being generated due to reductive circumstances in the crucible melter during vitrification of the spent resin.

10. The method as set forth in claim 9, wherein frit containing As, Ce and V of 5-valent is simultaneously fed to the crucible melter along with the spent resin and the DAWs.

11. The method as set forth in claim 10, wherein ozone is injected to the crucible melter, in which the spent resin is input, in order to completely burn the spent resin, and oxidize an inorganic material produced during burning of the spent resin.

12. The method as set forth in claim 10, wherein oxygen is injected to an upper portion of the crucible melter in order to maintain an oxidation atmosphere in the crucible melter while ensuring complete burning of the wastes upon simultaneous input of the wastes and the DAWs.

13. The method as set forth in claim 10, wherein the spent resin is fed at a rate of 4˜20 kg per hour, the DAWs is fed at a rate of 16˜80 kg per hour, and the frit containing As, Ce and V is fed at a rate of 2.2˜11 kg per hour to the crucible melter at a temperature of about 1,150±30° C. in order to maintain predetermined components of the molten glass, and an oxidation state in the crucible melter.
